(19) United States
(12) Patent Application Publication
(10) Pub. No.: US 2002/0072816 A1
(43) Pub. Date: Jun. 13, 2002

(54) Audio system

(76) Inventors: Yoav Shdema, Hertzelia (IL); Yossef Oren, Ramat Gan (IL); Effi Gannot, Ramat Gan (IL); Rafael D. Diaz, Caesarea (IL)

Correspondence Address: Merchant, Gould, Smith, Edell, Welter & Schmidt, 3200 IDS Center, 80 South Eighth Street, Minneapolis, MN, 55402, US

(21) Appl. No.: 09/732,044

(22) Filed: Dec. 7, 2000

(51) Int. Cl. G06F 17/00

(52) U.S. Cl. 700/94; 381/77

(57) ABSTRACT

Audio system for operating a plurality of speakers, the audio system including an audio management system connected to the speakers via a network, a user interface connected to the audio management system, and an audio source cluster connected to the audio management system, wherein the audio management system operates the speakers by transmitting audio streams and speaker audio control data to the network, and wherein the audio management system determines the speaker audio control data, according to a plurality of parameters.

### FIELD OF THE INVENTION

The present invention relates to communication systems in general, and to methods and systems for establishing an intelligent sound system, in particular.

### BACKGROUND OF THE INVENTION

Systems and methods for broadcasting an audio program from a set of remote speakers are known in the art. Such audio systems generally include an audio data source, a system for processing and selecting an audio signal, an amplifier for amplifying the selected signal and a plurality of speakers for reproducing the amplified signal at an audio device. Traditionally, the audio program system configures with multiple speakers cabled together. This configuration may include multiple networks or multiple zones with a common signal per zone.

U.S. Pat. No. 5,406,634 issued to Anderson et al., and entitled “Intelligent Speaker Element Unit for Speaker Element System Network”, is directed to an audio broadcast system. This system provides some of the advantages of the intelligence at the remote speaker element such as, selection of remote speakers, selection of channels and speakers and mixing of selected channels in the selected remote speaker element. The speaker element may be adjusted to its environment and all of these tasks may be accomplished remotely. The system includes a central processing unit (CPU), an analog audio source, a digital audio source, analog to digital converters (A/D), a multiplexor (MUX), a transmitter, a receiver, and a set of intelligent speakers connected to the transmitter and the receiver via separate buses. The intelligent speaker element includes a communications receiver, a communications transmitter, a digital signal processor (DSP), a digital to analog converter (D/A), an audio amplifier, a power supply and an address. The DSP processes the audio data in accordance with the control data. The control data includes an address for selecting the speaker element. When the DSP detects the address of the speaker element in the control command, the DSP is enabled to process audio data digitally based on parameters in the control data. The processed digital audio data is then converted to an analog signal, which is amplified and sent to the speaker element.

A system which provides a switching network for interconnective and active demonstration of consumer electronic products, is described in U.S. Pat. No. 5,646,602 issued to Gertz et al., which is entitled “Switching Network for Selective Product Demonstration”. This reference is directed to a switching network for selective product demonstration. The switching network provides features such as advanced noise suppression system, combining source, source mute and speaker element de-selection and a multiple speaker element selection ability to allow simultaneous demonstration of two or more speaker element pairs. The switching network further provides an automatic volume calibration, automatic sound pressure limiting and a built-in mechanism for indicating unauthorized disconnection of a product from the switching network. In this system, different product combinations may be compared instantaneously at identical volume levels and annoying sudden bursts of loud music are eliminated. The switching network includes a plurality of nodes: source nodes, amplifier nodes and speaker nodes. Each product on display is connected to a node. The total number of sources, amplifiers and speakers that may be interconnected through the source, amplifier and speaker nodes is essentially unlimited, but for practical purposes it can be up to 99. The switching network also includes a control means for supervising all network functions. The control means includes a micro-controller at each node to take advantage of the distributed intelligence architecture.

Transmission and reception systems for performing transmission and reception of various types of signals through a transmission line are described in U.S. Pat. No. 5,287,547 issued to Hidaka, and entitled “Transmission and Reception System”. The basic configuration of the transmission and reception system (FIG. 1) includes transmitting means 1, receiving means 2, transmission request signal output means 3, decoding means 4 and information signal output control means 5.

This system provides a transmission and reception capability in which an information signal from transmitting means 1 provided at a first location, is transmitted through a transmission line to be received by receiving means 2 provided at the second location. According to this system, an information signal sent through the transmission line is received by receiving means 2. The transmission request signal output means 3, provided at the second location includes the capability to encode a transmission request signal and to send the encoded transmission request signal to the transmission line. Decoding means 4 is also provided at the first location for receiving and decoding the transmission request signal. Information signal output control means 5 causes transmitting means 1, to output the information signal to the transmission line. At this time, information signal output control means 5 controls transmitting means 1 to cause transmitting means 1 to output an information signal to be received by receiving means 2.

U.S. Pat. No. 5,182,552 issued to Paynting, and entitled “Multiple Zone Audio System” is directed to a program signal processing system, which is monitored and controlled from one of many remote locations. The program sources are located at a central location. However, the program signal monitored at a remote location may originate from the program source at which the signal is being monitored (the central location or other locations), or from a different program source. The monitored signals are audio signals consist of a compact disc player, a radio tuner, a television, an audio signal tuner and an audio type player. The circuitry at the central location includes a central controller, and at least two independent selectors, which can be independently selected from the input sources for routing to an output channel. The circuitry may include at least two volume controllers responsive to the central controller. In order to assist control of the system, commands which are issued to the system from a remote interface, are verified by a verification signal added to the output signal sent to the output channels. The program signal processing system (FIG. 1) includes a plurality of program sources 100, a plurality of program signal selectors 110, a plurality of verify and processing blocks 120, a plurality of remote interfaces 140 and a central controller 130. Central controller 130 monitors and controls the operation of the program signal processing system, and supports remote interfaces 140 to control the system. In the embodiment shown in FIG. 2, the amplitude of the signal delivered by zone 1 and zone 2 remote speakers 260 is controlled by volume control circuits 231 and 232. Program signals from system 200 drive the speakers via amplifiers and speaker wires. Multiple remote controllers may be used with system 200. An arbitration scheme provides the controllers with exclusive control of volume and source selection for one zone, as well as the source functions for the selected source.

A method and apparatus for configuring plural multi-media audio cards as a local area network, are described in U.S. Pat. No. 5,519,641 issued to Beers et al., and entitled “Method and Apparatus for Configuring Plural Multimedia Audio Cards as a Local Area Network”. According to this method, a plurality of computers can be configured as a LAN (local area network) through the use of an audio card, cables, and a communication protocol. This system makes use of the line-in/line-out connectors for each right and left stereo channel of the audio card, to provide a communication network. The audio and data information can be transmitted simultaneously over the local area network. The distributed computers are connected in a master/slave configuration. All line-in ports of the slave systems are connected together, and the master system lineout port is connected to the slave systems line-in ports, for each channel. All lineout ports of the slave systems are connected together and the master system line-in port is connected to the slave systems lineout ports, for each channel. Only one slave lineout can actively transmit data at any time. A communication protocol is provided wherein the master system provides a clock signal on the control channel. During communication, if either the master or slave system recognize their address on the packet received on the line-in channel, then the information is decoded and processed by the digital signal processor on the audio card. The audio data can be output to the system as a play file or the like, while the data information may be sent directly to the host CPU in the system, either to the master or the slave, for display on the computer screen. This system also provides a multi-tasking program for controlling an onboard processor on the audio card. This will allow the simultaneous transmission and/or receipt of audio and data information and audio play or record by the systems interconnected in the local area network audio configuration.

U.S. Pat. No. 5,818,948 issued to Gulick, and entitled “Architecture for a Universal Serial Bus-Based PC Speaker Controller”, is directed to a system for transmission of audio signals to speakers, through a Universal Serial Bus (USB). A powered loudspeaker, compatible with a USB specification is described in this system. Powered speaker 108 (FIG. 5) includes a power supply 110, an amplifier 114, a USB controller 112 and a speaker 116. The USB controller is connected to a USB host interface, for example, of a PC. It is noted that a single USB port can host up to 127 devices and hence can host a plurality of such powered speakers, each receiving information through the USB bus, decoding it, and providing it to the internal amplifier 114 which is powered by the power supply unit 110. This system provides tone control, volume control and balance between left and right outputs (in a stereo version). Furthermore, power management function is provided. The system can place itself into a sleep mode via software from the host.

### SUMMARY OF THE PRESENT INVENTION

It is an object of the present invention to provide a novel method and system for operating a plurality of digital speakers connected to a digital audio network. In accordance with the present invention, there is thus provided an audio system for operating a plurality of speakers. The audio system includes an audio management system, a user interface and an audio source cluster. The audio management system is connected to the speakers via a network. The audio management system is connected to the user interface and to the audio source cluster. The audio management system operates the speakers by transmitting audio streams and speaker audio control data to the network. The audio management system determines the speaker audio control data, according to a plurality of parameters.

In accordance with another aspect of the present invention, there is thus provided a method for operating an audio system. The audio system includes an audio management system, a user interface, an audio source cluster and a plurality of speakers. The speakers are connected to the audio management system via a network, and the audio management system is connected to the user interface and to the audio source cluster. The method includes the steps of determining network audio control data, conforming audio streams, encoding the conformed audio streams and determining speaker audio control data. The network audio control data is determined according to automatic predetermined parameters and user defined parameters. The audio streams are conformed according to the network audio control parameters. The speaker audio control data is determined according to the automatic predetermined parameters and the user defined parameters.

In accordance with a further aspect of the present invention, there is thus provided a method for operating an audio system. The audio system includes an audio management system, a user interface, an audio source cluster and a plurality of speakers, wherein each of the speakers includes a speaker element. The speakers are connected to the audio management system via a network, and the audio management system is connected to the user interface and to the audio source cluster. The method includes the steps of amplifying an analog audio signal, providing the amplified analog audio signal to each of the speaker elements, detecting sounds from each of the speaker elements and producing an acoustic parameter respective of the sounds.

In accordance with another aspect of the present invention, there is thus provided a method for operating an audio system. The audio system includes an audio management system, a user interface, an audio source cluster and a plurality of speakers, wherein each of the speakers includes a speaker element. The speakers are connected to the audio management system via a network, and the audio management system is connected to the user interface and to the audio source cluster. The method includes the steps of performing a cross-over function on an analog audio signal, amplifying the analog audio signal for each of the speaker elements, detecting sounds from each of the speaker elements and producing an acoustic parameter respective of the sounds.

In accordance with a further aspect of the present invention, there is thus provided a method for operating an audio system. The audio system includes an audio management system, a user interface, an audio source cluster and a plurality of speakers, wherein each of the speakers includes a speaker element. The speakers are connected to the audio management system via a network, and the audio management system is connected to the user interface and to the audio source cluster. The method includes the steps of performing a cross-over function on an equalized analog audio signal, amplifying the equalized analog audio signal for each of the speaker elements, detecting sounds from each of the speaker elements, and producing an acoustic parameter respective of the sounds.

### BRIEF DESCRIPTION OF THE DRAWINGS

The present invention will be understood and appreciated more fully from the following detailed description taken in conjunction with the drawings in which:

FIG. 1 is a schematic illustration of an audio system, constructed and operative in accordance with a preferred embodiment of the present invention;

FIG. 2 is a schematic illustration in detail of the audio management system of FIG. 1, constructed and operative in accordance with another preferred embodiment of the present invention;

FIG. 3 is a schematic illustration in detail of the audio source cluster of FIG. 1, constructed and operative in accordance with a further embodiment of the present invention;

FIG. 4 is a schematic illustration in detail of one of the computerized speakers of the system of FIG. 1, constructed and operative in accordance with another preferred embodiment of the present invention;

FIG. 5 is a schematic illustration in detail of another computerized speaker of the system of FIG. 1, constructed and operative in accordance with another preferred embodiment of the present invention;

FIG. 6 is a schematic illustration of a ring type configured audio system, constructed and operative in accordance with a further preferred embodiment of the present invention;

FIG. 7 is a schematic illustration in detail of a further computerized speaker of the system of FIG. 1, constructed and operative in accordance with another preferred embodiment of the present invention;

FIG. 8 is an illustration of a method for managing audio, operative in accordance with another preferred embodiment of the present invention. The method of FIG. 8 can be used for operating audio management system 100 of FIG. 1;

FIG. 9 is an illustration of a method for operating a computerized speaker 114A of FIG. 4, operative in accordance with another preferred embodiment of the present invention;

FIG. 10, which is an illustration of a method for operating a computerized speaker 114D of FIG. 12, operative in accordance with another preferred embodiment of the present invention.

FIG. 11 is an illustration of a method for operating a computerized speaker 114B of FIG. 5, operative in accordance with another preferred embodiment of the present invention;

FIG. 12 is a schematic illustration in detail of another computerized speaker of the system of FIG. 1, constructed and operative in accordance with another preferred embodiment of the present invention.

### DETAILED DESCRIPTION OF PREFERRED EMBODIMENTS

The present invention overcomes the disadvantages of the prior art by providing a digital networked audio system and a method for operating the same, with digital speakers, which include internal and ambient dynamic audio processing, amplification and psycho-acoustic manipulation (i.e., creating a sensation of acoustic depth through surround sound techniques) of the received audio stream. The invention preferably makes use of a digital communication link, which is based on digital isochronous communication concept. A digital isochronous communication channel guarantees predetermined bandwidth (for example, at least at 44.1 k-bit/sec) for each network address (i.e., digital speaker device) in the network. The use of digital isochronous communication eliminates any noticeable delay in network traffic. It will be appreciated by those skilled in the art that such delay exists when using conventional networking protocols such as Voice Over IP (VoIP), and the like.

The digital speakers are a set of network devices, identified by a unique address, and can attach/detach themselves without requiring reboot of the network, or re-initialization. This is due to the fact that isochronous protocols funnel the information regardless of the existence of the network device as a network link. Hence, such a communication channel does not exhibit packet loss. The digital samples can be packetized (as in Internet Protocols) or can be transmitted without packet overhead (e.g., Header/Footer/Parity). It is noted that the present invention can make further use of conventional networking protocols such as Ethernet, ATM, and the like, for conveying control data between the network devices and the audio management system.

The speed of sound has a considerable effect on large-scale sound systems employing a large number of speakers, which are spread over a large area. A listener located at a certain location within that area, receives the sound from each speaker at a delay, which is proportional to his distance from that speaker. For example, in an open field concert, which employs front-end speakers and rear-end speakers, all of which are directed at the audience, the rear-end listeners would hear the front-end speakers, at a delay from the rear-end speakers. The delay D equals the distance between the front-end speakers and the rear-end speakers, divided by the speed of sound.

According to one aspect of the invention, the sound produced by the rear-end speakers is delayed by D, with reference to the sound produced by the front-end speakers. Hence, the rear-end listeners receive both sounds at the same phase. The digital isochronous communication protocols enable a unique capability to program the delay element associated with each of the devices as a fixed delay. This can be used to accurately calculate all delays associated with the digital communication link. Hence, the use of digital isochronous communication protocols nullifies dynamic delay in the audio system, and eliminates the need for echo cancellation procedures, and protocols associated with various communication links.

Digital isochronous protocols, for use with the present invention to funnel digital audio data to the remote speakers, can be selected form the list consisting of low level Universal Serial Bus (USB), high speed IEEE1394, Short Distance Wireless Blue-tooth format, and the like. The open network topology, used for connecting the digital speakers, can be ring, star, or a combination of ring and star.

In addition, these protocols and their specifications provide tools and services, which facilitate interoperability and development of distributed applications on communication networks, such as home networks. For example, the API used in IEEE1394 is based on the Home Audio/Video Interoperability (HAVi) Specification 1.0.

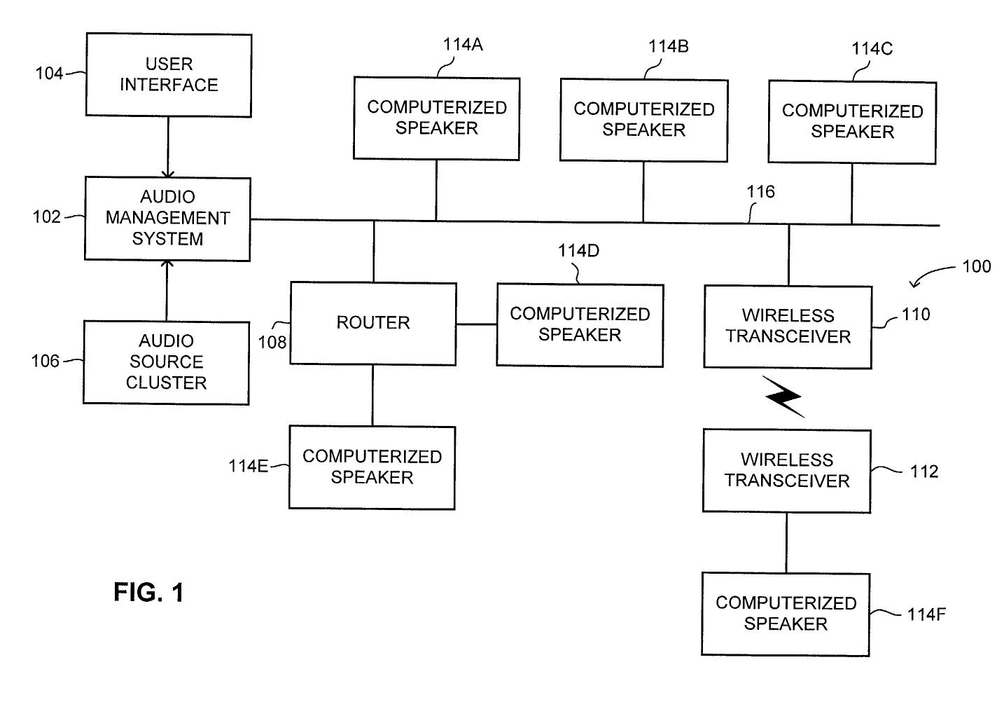

Reference is now made to FIG. 1, which is a schematic illustration of an audio system, generally referenced 100, constructed and operative in accordance with a preferred embodiment of the present invention. Audio system 100 includes an audio management system 102, a user interface 104, an audio source cluster 106, a router 108, wireless transceivers 110 and 112, and a plurality of computerized speakers 114A, 114B, 114C, 114D, 114E, 114F and network 116.

Audio management system 102 is connected to audio source cluster 106, to user interface 104 and to network 116. Network 116 is further connected to computerized speakers 114A, 114B, 114C, to router 108 and to wireless transceiver 110. Router 108 is further connected to computerized speakers 114D and 114E. Wireless transceiver 112 is connected to computerized speaker 114F. Wireless transceiver 110 is wirelessly coupled to wireless transceiver 112.

Network 116 provides at least one isochronous channel, which maintains fixed bandwidth. The number of network speakers, connected to the network, is virtually unlimited, according to the available network addresses. According to a preferred embodiment of the present invention, audio data transmitted over network 116, utilizes digital isochronous communication links (channels), where the following is a short introduction therefor.

Audio management system 102 receives audio streams in digital and analog form from audio source cluster 106. User interface 104 provides user commands to audio management system 102 for processing the received audio streams.

Audio management system 102 determines network audio control data according to automatic predetermined and user defined parameters. Audio management system 102 processes the audio streams according to the user commands, network audio control data and produces speaker audio control data, respective of various audio parameters, such as volume, balance, equalization, harmonic envelope, echo and audio effects, and the like. Audio management system 102 transmits the audio streams and the speaker audio control data to remote computerized speakers via network 116. Router 108 provides scalable coupling of additional computerized speakers (such as the ones referenced 114D and 114E) to network 116. Computerized speaker 114F is wirelessly connected to network 116 via transceivers 110 and 112.

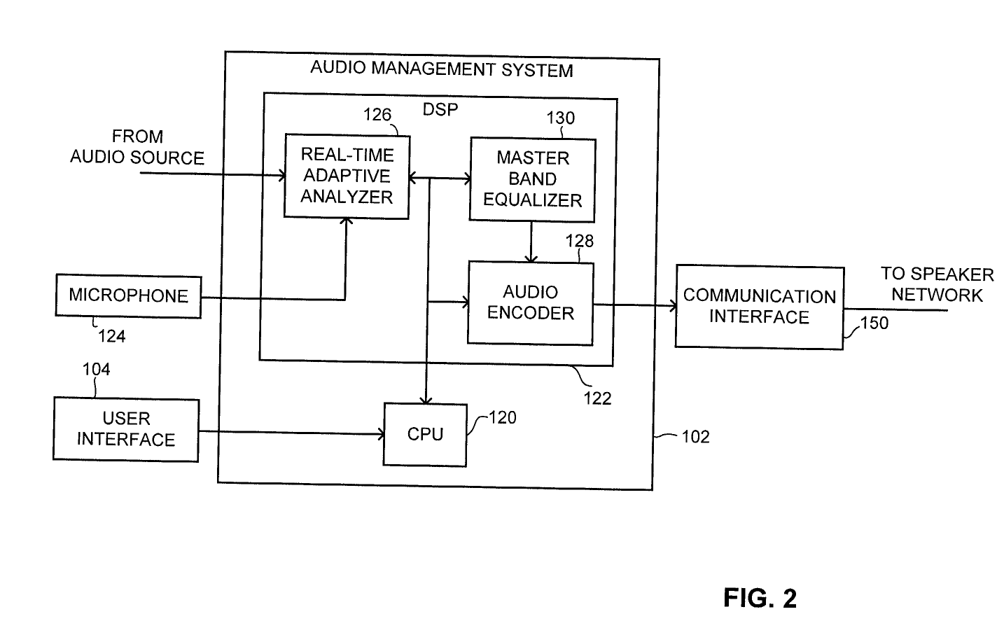

Reference is now made to FIG. 2, which is a schematic illustration in detail of audio management system 102 of FIG. 1, constructed and operative in accordance with another preferred embodiment of the present invention. Audio management system 102 includes a central processing unit (CPU) 120 and a digital signal processor (DSP) 122. DSP 122 includes a real-time adaptive analyzer 126, an audio encoder 128 and a master band equalizer 130.

CPU 120 is connected to user interface 104 (FIG. 1), DSP 122, real-time adaptive analyzer 126, audio encoder 128 and to master band equalizer 130. Real-time adaptive analyzer 126 is further connected to a microphone 124, audio encoder 128, master band equalizer 130 and to CPU 120. Microphone 124 can be placed at various locations within the system. Audio encoder 128 is further connected to master band equalizer 130 and to communication interface 150.

Audio management system 102 receives a plurality of digital and analog audio streams from audio source cluster 106 (FIG. 1), and processes and transforms the digital audio streams according to control parameters (predetermined parameters of the speaker audio control data and of the network audio control data). Control parameters, such as volume, balance, equalization, harmonic envelope, echo and audio effects, and the like, are either defined by the user or determined automatically, using feedback mechanisms.

CPU 120 controls and manages the general operation of audio management system 102. User interface 104 receives control parameter selection from a user operating the system. User interface 104 provides the received control parameters to CPU 120, which in turn updates the settings of the modules connected thereto.

DSP 122 decodes the multiplexed digital audio streams received from audio source cluster 106 of FIG. 1. The received digital audio streams may be provided in any conventional or proprietary format, such as Dolby Logic, Dolby Pro-Logic, Dolby Digital 5.1 channels (AC3 format), Digital Theatrical Sound (DTS Format), Ultimate Computerized Pro-Audio Sound System (UCPASS) multi-channel encoded audio source, and the like. The system can be adapted to support any future sound-encoding format. The decoding operation can include any operation required to produce a digital representation of the audio streams, which can then be audio analyzed. These operations can include de-multiplexing, separating the various audio streams, converting from one digital format to another, and the like.

DSP 122 incorporates an audio decoding layer, which expands the compressed audio streams. The audio decoding layer employs the pulse code modulation (PCM) scheme. DSP 122 funnels each of the PCM decoded streams to a selected speaker. This operation can be performed in the process of encoding the streams. DSP 122 sends a control sequence to the selected speaker, which configures that speaker to operate according to selected format. The DSP 122 can further produce an indication to the user, via the user interface. According to one embodiment of the invention, this audio decoding layer supports MPEG-3, also known in the industry as MP3 format.

Audio source cluster 106 (FIG. 1) provides the digital and analog audio streams to real time adaptive analyzer 126. CPU 120 provides control parameters to real time adaptive analyzer 126. Real time adaptive analyzer 126 further receives audio feedback from microphone 124. Thereby, the extracted sound parameters from PCM highway are funneled to the channels of audio management system 102. Real time adaptive analyzer 126 analyzes the digital audio streams according to the control parameters and the audio feedback, determines the difference between them and updates the settings of the master band equalizer 130, in real time.

Master band equalizer 130 transforms the digital audio streams according to the settings provided by real time adaptive analyzer 126 and initial equalization parameters, which are set by the listener. For example, master band equalizer 130 can receive a plurality of equalization parameter sets, each set for a selected band pass filter, of the plurality of band pass filters which are defined for the system. For example, the system can operate according to a total of sixty-two band pass filters, at a resolution of one sixth of an octave each. Each of the parameter sets can include parameters such as quality sharpness of the band-pass filter, gain of the filter (e.g., +/−18 db), and the like.

Master band equalizer 130 can operate in two alternative modes, an automatic mode and a manual mode. In the automatic mode, master band equalizer 130 receives a parameter set for each band-pass filter, directly from the real-time adaptive analyzer. In the manual mode, user interface 104 updates various parameters directly, as desired by the user operating the system. In the manual mode, the parameter set of each of the band-pass filters can be selected by placing the mouse cursor on the slide control knobs depicted in a selected window of the user interface. Dragging each control knob up or down with the mouse, changes the values of these parameters.

It is noted that a master-bass and a master-treble control provide a general-purpose compatibility of a plurality of amplifiers certified on the audio market. The master-bass control is a proprietary air-band, controlled by a plurality of band-pass filter switches. The master-bass control and master-treble control, provide audio streams in logarithmic scales of 0-100 Hz and 2.5-22 kHz, respectively, to the respective amplifier. The master-bass control and the master-treble control are selected band pass filters, which provide audio streams to respective amplifiers with logarithmic scale at 0-100 Hz and logarithmic scale at 10 kHz-22 kHz accordingly. User interface 104 provides data to the user and receives user selections from the user, via a variety of input and output devices such as video, audio (e.g., sound and voice recognition, and the like), tactile (e.g., keyboard, mouse, general pointing devices), and the like. In the automatic mode, user interface 104 provides initial settings of the control parameters. Real time adaptive analyzer 126 compares the feedback stream with the transmitted audio streams so as to determine the difference there between two and provide the required update in the control parameters. The predetermined policies set limits for the actual update, which is finally introduced to the audio control data parameters. It is noted that the update can either be of network control parameters or of the speaker element control parameters, or both.

Audio encoder 128 receives the equalized digital audio streams, encodes them and transmits the encoded streams to communication interface 150. Alternatively, audio management system 102 can disable the audio encoding operation of audio encoder 128, and transmit the digital audio streams to the computerized speakers, without encoding. CPU 120 provides speaker element control parameters to audio encoder 128, which encodes them according to a predetermined format, and provides the encoded speaker element control parameters to communication interface 150, for further transmitting to the digital speaker elements. The corrected speaker element control parameters (delay, volume, equalization, cross, and the like) can be dynamically adapted for maintaining an optimum operating condition. An optimum operating condition can be an optimum frequency response, optimum phase relations throughout the audible spectrum, and the like.

In the present invention, real time adaptive analyzer 126 maintains a status and a configuration of “last” operation. The user can always recall a previous setting of the audio system. Furthermore, the audio system can automatically recall a plurality of user defined sound parameters (or parameter sets—profiles), such as Concert, Classical-Hall, Jazz, Stadium, Pop, Rock, and the like from a preset menu and a plurality of user program registers. These predefined profiles can be stored in a storage unit (not shown) or received from a user operated storage device, such as a diskette, a memory smart card, and the like.

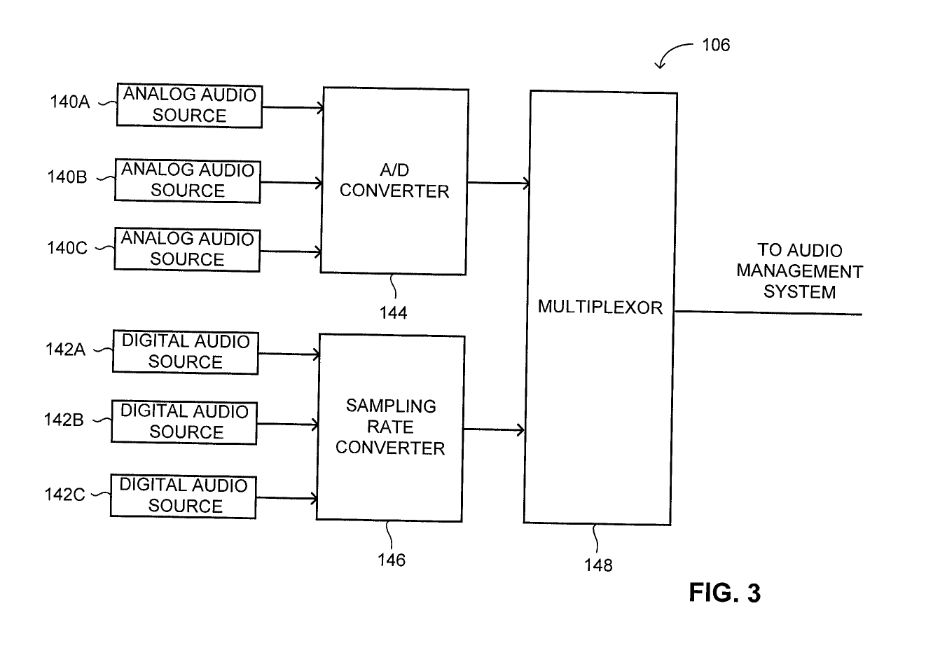

Reference is further made to FIG. 3, which is a schematic illustration in detail of the audio source cluster 106 of FIG. 1, constructed and operative in accordance with a further embodiment of the present invention. Audio source cluster 106 includes a plurality of analog audio sources 140A, 140B and 140C, a plurality of digital audio sources 142A, 142B and 142C, an analog to digital converter (A/D) 144, a sampling rate converter 146 and a multiplexor 148.

A/D converter 144 is connected to analog audio sources 140A, 140B and 140C and to multiplexor 148. Sampling rate converter 146 is connected to digital audio sources 142A, 142B and 142C and to multiplexor 148. Multiplexor 148 is further connected to audio management system 102 (FIG. 1). An audio signal can either be an analog audio signal (when received from analog audio sources 140A, 140B and 140C) or a digital audio signal (when received from digital audio sources 142A, 142B and 142C).

A/D converter 144 receives the analog audio signal from each of analog audio sources 140A, 140B and 140C, converts these analog audio signals to the digital audio streams and transmits that digital audio streams to multiplexor 148. Sampling rate converter 146 receives digital audio streams from digital audio sources 142A, 142B and 142C, converts a sampling rate of the digital audio streams to a selected digital-sampling rate. In the present example, the selected sampling rate is 96.0 kb/sec. Sampling rate converter 146 provides the digital audio streams at the selected sampling rate, to multiplexor 148. Multiplexor 148 multiplexes the digital audio streams, received from sampling rate converter 146 and A/D converter 144 and provides the multiplexed audio streams to audio management system 102 (FIG. 1).

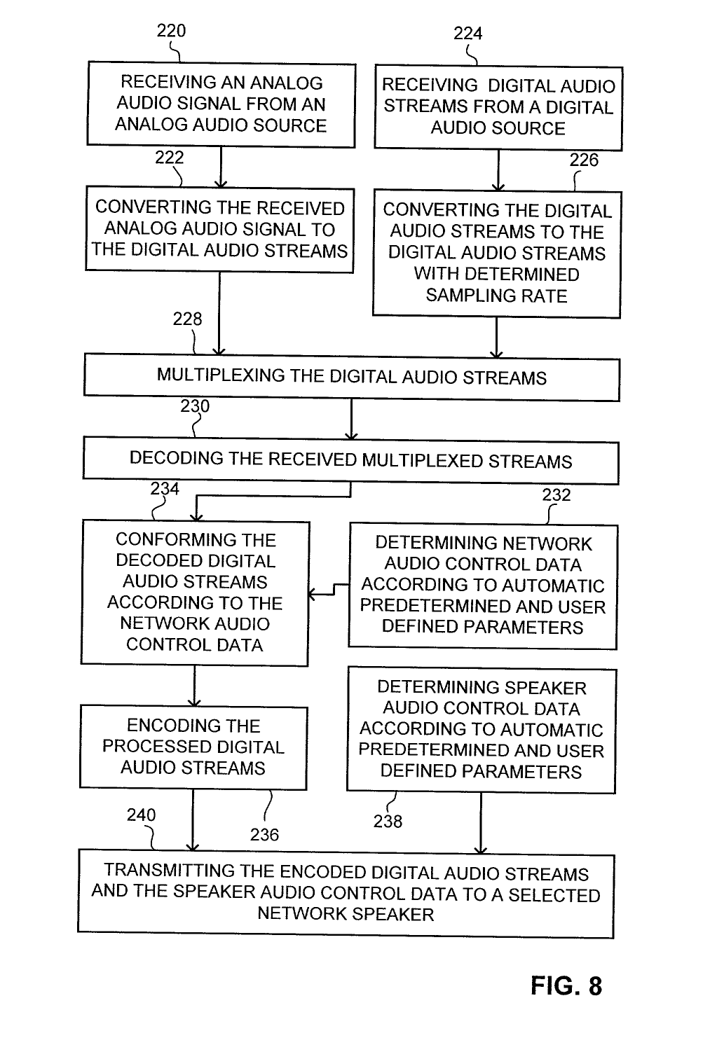

Reference is now made to FIG. 8, which is an illustration of a method for managing audio, operative in accordance with another preferred embodiment of the present invention. The method of FIG. 8 can be used for operating audio management system 100 of FIG. 1.

In step 220, an analog audio signal is received from an analog audio source. The analog source can be an analog output of any known media device, such as a CD player, a sound card, a television set, a radio device, and the like. It is noted that such a device can provide a plurality of related analog signals, such as in stereo, surround sound, multiple language translation, and the like. With reference to FIG. 3, A/D converter 144 receives analog signals, from either of the analog audio sources 140A, 140B and 140C.

In step 222, the received analog audio signal is converted to digital audio streams. With reference to FIG. 3, A/D converter 144 converts the received audio signals to digital audio streams.

In step 224, digital audio streams are received from a digital audio source. The digital source can be any known media device, such as a CD player, a DVD player, a digital Set-Top Box, a Digital Console, and the like, having a digital audio stream output. With reference to FIG. 3, sampling rate converter 146 receives the digital streams, from either of the digital audio sources 142A, 142B and 142C.

In step 226, the received digital audio streams are converted according to a selected sampling rate. With reference to FIG. 3, sampling rate converter 146 converts received digital audio streams, to a selected digital sampling rate (in the present example, the selected sampling rate is 96.0 kb/sec).

In step 228, the digital audio streams are multiplexed. With reference to FIG. 3, multiplexor 148 multiplexes the digital audio streams received from A/D converter 144 and the digital audio streams received from sampling rate converter 146.

In step 230, the multiplexed digital audio streams are decoded. The decoding operation can include any operation required to produce a digital representation of the audio streams, which can be audio analyzed. These operations can include de-multiplexing, separating the various audio streams, converting from one digital format to another, and the like. With reference to FIG. 2, DSP 122 decodes the multiplexed digital audio streams received from audio source cluster 106 of FIG. 1. It is noted that DSP 122 can include a dedicated decoding module for these purposes (not shown).

In step 232, network audio control data is determined according to automatic predetermined parameters (by using a feedback mechanism) and user defined parameters. The network audio control data can include a plurality of various audio parameters, such as volume, balance, equalization, harmonic envelope, echo and audio effects, and the like. These parameters can continuously be updated by a feedback mechanism. Alternatively, these parameters can be set by a user. With reference to FIG. 2, the user provides CPU 120 with his selection of the settings for the audio parameters via user interface 104. The user selections can further include audio feedback policies, surround settings, and the like. CPU 120 provides these settings to real-time adaptive analyzer 126, which further receives feedback signal from microphone 124. Real-time adaptive analyzer 126 analyzes the received audio streams with respect to the parameters and the feedback signal and updates the settings of the master band equalizer 130.

In step 234, the decoded digital audio streams are conformed according to the determined network audio control data. This procedure is preferably performed in real time. With reference to FIG. 2, master band equalizer 130 conforms the digital audio streams according to audio data provided by real-time adaptive analyzer 126. For example, if a selected frequency is set to be at a predetermined volume level and the feedback signal indicates that it was produced beyond that level (with respect to other frequencies), then, this frequency can be somewhat diminished from now on so as to achieve the original settings.

In step 236, the processed digital audio streams are encoded. It is noted that this step of encoding can be eliminated. With reference to FIG. 2, audio encoder 128 encodes the digital audio streams received from master band equalizer 130. Alternatively, audio management system 102 can disable audio encoding operation of audio encoder 128 and so to transmit the digital audio streams to the computerized speakers, without encoding.

In step 238, speaker audio control data is determined according to automatic predetermined parameters (by using a feedback mechanism) and user defined parameters. The speaker audio control data can include a plurality of audio parameters, such as volume, balance, equalization, harmonic envelope, echo and audio effects, phase, time-delay, and the like. These parameters can continuously be updated by a feedback mechanism. Alternatively, these parameters can be set by a user. With reference to FIG. 2, the user provides CPU 120 with his selection of the settings for the audio parameters via user interface 104. The user selections can further include audio feedback policies, surround settings, and the like. CPU 120 provides these settings to real-time adaptive analyzer 126, which further receives feedback signal from microphone 124. Real-time adaptive analyzer 126 analyzes the audio streams received with respect to the parameters and the feedback signal and updates the settings of the master band equalizer 130. Thus, either audio management system 102 or the user can perform high speed switching of each of the speaker elements. For example, the user can convert a two-way speaker to two separate speakers.

In step 240, the digital audio streams (encoded or otherwise) and the speaker audio control data are transmitted to a selected network speaker. With reference to FIG. 2, communication interface 150 transmits each of the digital audio streams to a selected network speaker 114A, 114B, 114C, 114D, 114E and 114F (FIG. 1). In addition, communication interface 150 further transmits respective speaker audio control data, received from the audio management system 102, to each of the network speakers 114A, 114B, 114C, 114D, 114E and 114F. It is noted that each of the digital audio streams can be transmitted to each of the speakers and furthermore, to selected sections of different speakers (e.g., the high portion of the stream being transmitted to the high section of one speaker and the low portion of that same stream being transmitted to the low section of another speaker).

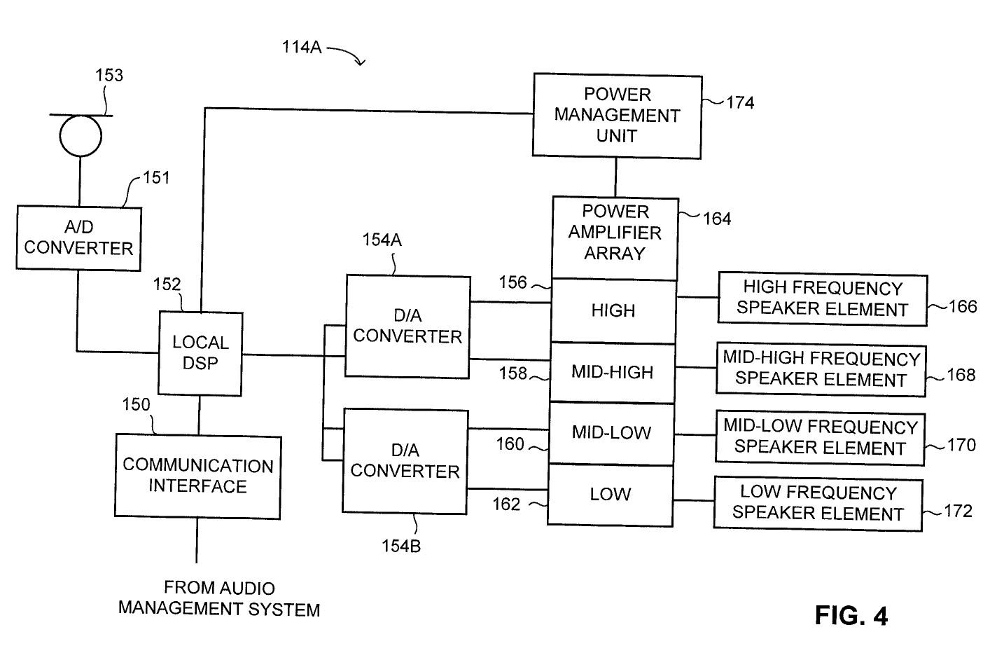

Reference is now made to FIG. 4, which is a schematic illustration of computerized speaker 114A of FIG. 1, constructed and operative in accordance with a further preferred embodiment of the present invention. Computerized speaker 114A includes a communication interface 150, a local DSP 152, an analog to digital (A/D) converter 151, a microphone 153, digital to analog converters (D/A) 154A and 154B, a power amplifier array 164, a power management unit 174, a high frequency speaker element 166, a mid-high frequency speaker element 168, a mid-low frequency speaker element 170 and a low frequency speaker element 172. Power amplifier array 164 includes a high frequency bandwidth amplifier 156, a mid-high frequency bandwidth amplifier 158, a mid-low frequency bandwidth amplifier 160 and a low frequency bandwidth amplifier 162.

Local DSP 152 is connected to communication interface 150, A/D converter 151, D/A converters 154A and 154B, and to power management unit 174. Microphone 153 is connected to A/D converter 151. Power amplifier array 164 is connected to D/A converters 154A and 154B and to power management unit 174.

High frequency bandwidth amplifier 156 is connected to D/A converter 154A and to high frequency speaker element 166. Mid-high frequency bandwidth amplifier 158 is connected to D/A converter 154A and to mid-high frequency speaker element 168. Mid-Low frequency bandwidth amplifier 160 is connected to D/A converter 154B and to mid-low frequency speaker element 170. low frequency bandwidth amplifier 162 is connected to D/A converter 154B and to low frequency speaker element 172.

Communication interface 150 receives digital audio streams and speaker audio control data from audio management system 102 (FIG. 2), and provides the streams and data to local DSP 152. Local DSP 152 processes the received digital audio streams according to speaker audio control data, thereby producing four digital audio streams (such as streams from different channels of a stereo audio system, and the like). It is noted that the digital audio streams can include predetermined and already separated digital audio streams, one for each band (i.e., high, mid-high range, mid-low and low), or a single full band stream, on which the local DSP 152 applies a cross-over function.

Local DSP 152 provides each of the processed audio streams to the respective D/A input port. Local DSP 152 processes the speaker element control data, thereby producing amplification commands, designated for each of the amplifiers of power amplifier array 164, and applies amplification commands to power management unit 174. An amplification command can be an on-off command, volume control, percentage of the maximum amplifier gain during operation, and the like.

D/A converter 154A receives the high frequency digital audio stream and the mid-high frequency digital audio stream from local DSP 152, converts each of these streams to a respective analog audio signal. D/A converter 154A, furthermore directs the high frequency analog signal to high frequency bandwidth amplifier 156 and the mid-high frequency analog signal to mid-high frequency bandwidth amplifier 158. D/A converter 154B receives the mid-low frequency digital audio stream and the low frequency digital audio stream from local DSP 152. D/A converter 154B converts these streams to respective analog audio signals and directs the mid-low frequency analog signal to mid-low frequency bandwidth amplifier 160 and the low frequency analog signal to low frequency bandwidth amplifier 162.

Power management unit 174 provides high electric power, required to operate power amplifier array 164. Power amplifier array 164 amplifies the analog audio signals separately and provides each amplified signal to the respective speaker element. High frequency bandwidth amplifier 156 receives the high frequency audio signal from D/A converter 154A and amplification commands from power management unit 174. High frequency bandwidth amplifier 156 amplifies the high frequency audio signal, according to the amplification commands and provides the amplified signal to high frequency speaker element 166.

Mid-high frequency bandwidth amplifier 158 receives the mid-high frequency audio signal from D/A converter 154A and amplification commands from power management unit 174. Mid-high frequency bandwidth amplifier 158 amplifies the mid-high frequency audio signal, according to the amplification commands and provides the amplified signal to mid-high frequency speaker element 168.

Mid-Low frequency bandwidth amplifier 160 receives the mid-low frequency audio signal from D/A converter 154B and amplification commands from power management unit 174. Mid-Low frequency bandwidth amplifier 160 amplifies the mid-low frequency audio signal, according to the amplification commands and provides the amplified signal to mid-low frequency speaker element 170.

Low frequency bandwidth amplifier 162 receives the low frequency audio signal from D/A converter 154B and amplification commands from power management unit 174. Low frequency bandwidth amplifier 162 amplifies the low frequency audio signal, according to the amplification commands and provides the amplified signal to low frequency speaker element 172.

It is noted that the amplification commands can be dynamic and can further be influenced by equalization and cross-over processes. Each specific speaker element: 166, 168, 170 or 172 receives the amplified analog audio signal and produces respective sound signals.

When a computerized speaker unit such as the one referenced 114A, is connected to a network, it initiates a “handshake” procedure with the various nodes residing on the network, and provides a list of settings and characteristics thereof. For example, the computerized speaker can provide information relating to the physical structure thereof, frequency responses, amplification ability, harmonic distortion values, protocol support, programmable aspects (e.g., internal equalizer and cross-over modules), cross over configuration (e.g., 1-way, 2-way, 3-way and N-way), and the like.

In most cases, the computerized speaker would perform the handshake procedure with the audio management system, which operates as a communication server. The audio management system receives the settings of the computerized speaker that was just introduced to the network, and updates the main program with these parameters.

A/D converter 151 receives analog signals from microphone 153, converts them to digital signals and sends the digital signals to local DSP 152. Microphone 153 continuously transmits audio feedback signal to local DSP 152. Local DSP 152 compares the signals from communication interface 150 and A/D converter 151, and controls the operation of speaker elements 166, 168, 170 and 172 according to the outcome of this comparison.

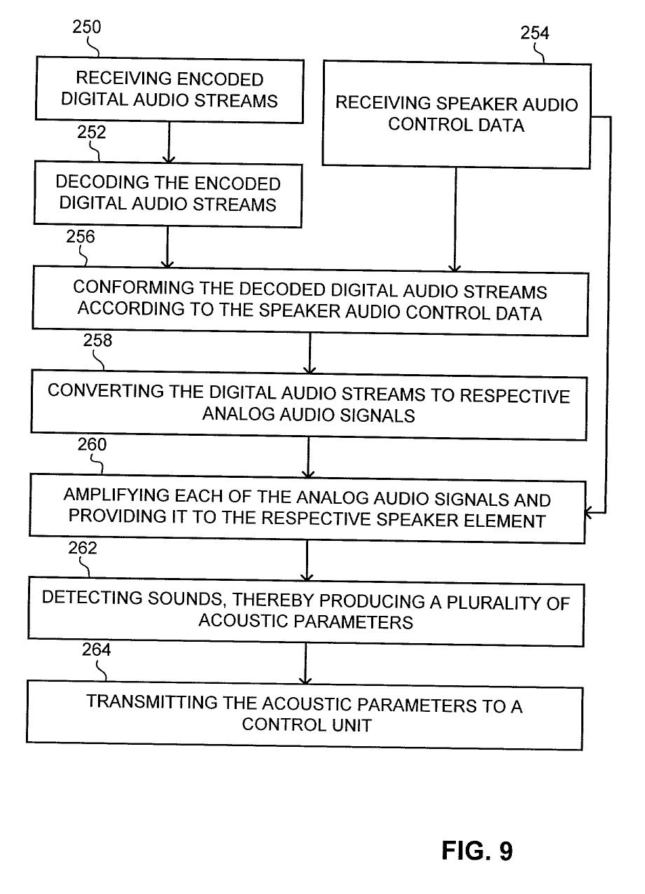

Reference is now made to FIG. 9, which is an illustration of a method for operating a computerized speaker 114A of FIG. 4, operative in accordance with another preferred embodiment of the present invention. In step 250, encoded digital audio streams are received. It is noted that the digital audio streams can be received in an un-encoded format, if transmitted as such. Further more, the received streams can include one stream or more, which can further be directed to a specific speaker element as will be described in detail herein below. With reference to FIG. 4, communication interface 150 receives encoded digital audio streams, transmitted by audio management system 102 of FIG. 1.

In step 252, the encoded digital audio streams are decoded. It is noted that this step can be eliminated when the digital audio streams are received in an un-encoded format. With reference to FIG. 4, local DSP 152 encodes the digital audio streams received from communication interface 150.

In step 254, speaker audio control data is received. The received speaker audio control data can include a plurality of predetermined parameters such as volume, equalization, active cross-over, and the like. With reference to FIG. 4, local DSP 152 receives the speaker audio control data from communication interface 150.

In step 256, the decoded digital audio streams are conformed according to the speaker audio control data. With reference to FIG. 4, local DSP 152 conforms the digital audio streams according to the speaker audio control data. For example, local DSP 152 equalizes the digital audio streams, applies acoustic filters and functions, adds audible effects, and the like. In addition, the DSP 152 further applies a cross-over function on the final streams, according to the acoustic specification of the speaker elements, the acoustic design of the speaker chambers and override parameters which can be induced by the audio management system 102 (FIG. 1).

In step 258, the digital audio streams are converted to respective analog audio signals. With reference to FIG. 4, each of the D/A converters converts the received digital audio streams in the separate channel. D/A converter 154A receives the high frequency digital audio stream and the mid-high frequency digital audio stream from local DSP 152 and converts these streams to analog audio signals of the high frequency and mid-high frequency, accordingly. D/A converter 154B receives the mid-low frequency digital audio stream and the low frequency digital audio stream from local DSP 152 and converts these streams to analog audio signals of the mid-low frequency and low frequency, accordingly.

In step 260, each of the analog audio signals is amplified respective of its destination speaker element. With reference to FIG. 4, power amplifier array 164 amplifies the analog audio signals received from D/A converters 154A and 154B. It is noted that local DSP 152 produces amplification commands, designated for each of the amplifiers of power amplifier array 164, according to the speaker audio control data and frequency limitation for each separate amplifier. The amplified audio signals are provided to each separate speaker, which produce sound.

In step 262, sounds are detected, thereby a plurality of acoustic parameters is produced. Microphone 124 (FIG. 2) can continuously transmit audio feedback to audio management system 102 (FIG. 1), and microphone 124 provides feedback audio data for continuous management of sound system 100 (FIG. 1) in an automatic mode.

In step 264, the acoustic parameters are transmitted to a control unit. With reference to FIG. 2, microphone 124 transmits these acoustic parameters to DSP 122. Alternatively, if a computerized speaker includes an integrated microphone, then the DSP thereof can transmit acoustic parameters detected by that microphone to DSP 122, via network 116.

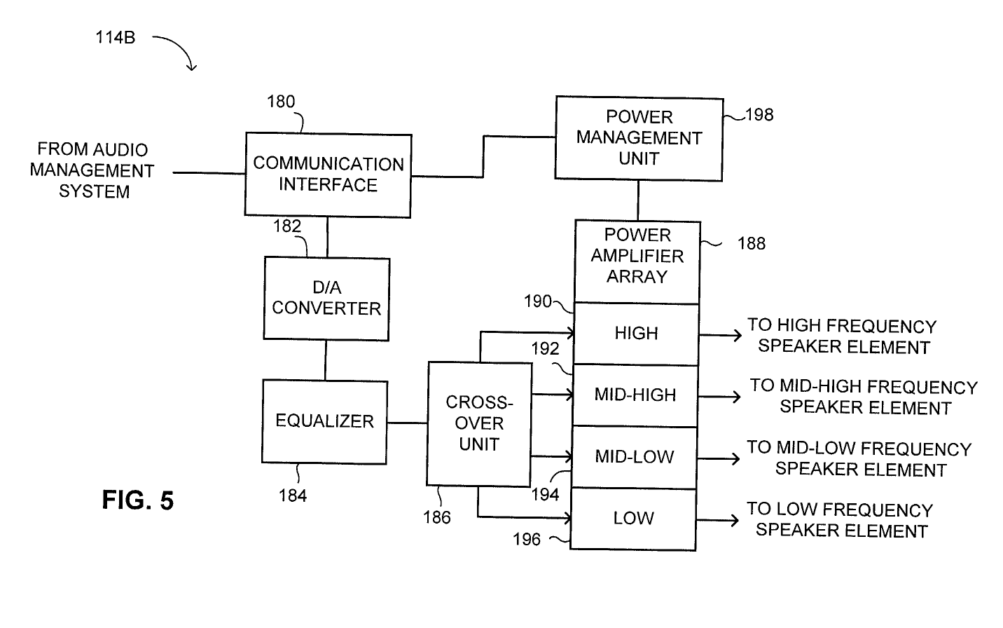

Reference is further made to FIG. 5, which is a schematic illustration in detail of computerized speaker 114B of FIG. 1, constructed and operative in accordance with a further preferred embodiment of the present invention. Computerized speaker 114B includes a communication interface 180, a digital to analog converter (D/A) 182, an equalizer 184, a cross-over unit 186, a power amplifier array 188 and a power management unit 198. Power amplifier array 188 includes a high frequency bandwidth amplifier 190, a mid-high frequency bandwidth amplifier 192, a mid-low frequency bandwidth amplifier 194 and a low frequency bandwidth amplifier 196.

Communication interface 180 is connected to D/A converter 182, power management unit 198 and to network 116 (FIG. 1). Equalizer 184 is connected to D/A converter 182 and to cross-over unit 186. Power amplifier array 188 is connected to cross-over unit 186 and to power management unit 198.

Communication interface 180 receives data from audio management system 102 (FIG. 1) via network 116 (FIG. 1). This data includes a digital audio stream and amplification commands. Communication interface 180 provides the received digital audio stream to D/A converter 182, which in turn converts the digital audio stream to analog audio signal and further provides it to equalizer 184. Communication interface 180 provides the amplification commands to power management unit 198. Equalizer 184 equalizes the analog signal, according to predetermined equalization parameters, and provides the equalized audio signal to cross-over unit 186.

Cross-over unit 186 applies a cross-over function to the equalized analog signal, according to predetermined cross-over parameters respective of the structure of computerized speaker 114B, thereby producing a plurality of analog audio signals. Cross-over unit 186 provides each of the analog audio signals to the respective amplification unit in power amplifier array 188, which in turn amplifies the analog audio signals according to amplification commands received from power management unit 198. Power amplifier array 188, then provides the amplified signal to the respective speaker elements (not shown) connected thereto. It is noted that computerized speaker 114B can be manufactured and sold without the speaker elements, which can then be added later, according to the preferences of the final user or an end-user system manufacturer. Accordingly, the equalization parameters and cross-over parameters can be modified according to the selected speaker elements, at that later stage.

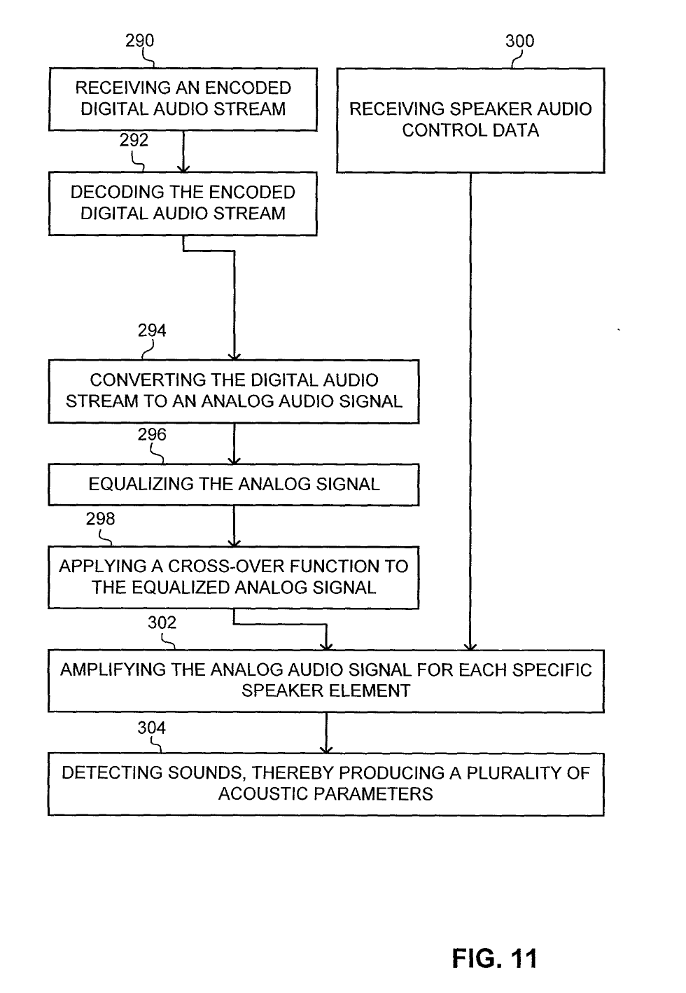

Reference is now made to FIG. 11, which is an illustration of a method for operating computerized speaker 114B of FIG. 5, operative in accordance with another preferred embodiment of the present invention. In step 290, an encoded digital audio stream is received. It is noted that the digital audio stream can be received in an un-encoded format, if transmitted as such. With reference to FIG. 5, communication interface 180 receives an encoded digital audio stream, transmitted by audio management system 102 of FIG. 1.

In step 292, the encoded digital audio stream is decoded. It is noted that this step can be eliminated when the digital audio stream is received in an un-encoded format. With reference to FIG. 5, communication interface 180 decodes the digital audio stream, received from audio management system 102 of FIG. 1.

In step 294, the digital audio stream is converted to analog audio signal. With reference to FIG. 5, D/A converter 182 converts the digital audio stream, received from communication interface 180 to analog audio signal.

In step 296 the analog audio signal is equalized according to pre-set equalization parameters. It is noted that the equalization parameters can be pre-set in the equalization unit of the computerized speaker according to the acoustic and electronic characteristics of the elements comprising the computerized speaker. With reference to FIG. 5, equalizer 184 equalizes the analog audio signal received from D/A converter 182

In step 298, a cross-over function is applied to the equalized analog audio signal. The cross-over function is predetermined according to the acoustic and electronic characteristics of the elements comprising the computerized speaker. For example, the cross-over function can be a band-pass, a band-cross, a high-pass, a low-pass digital filter, and the like. With reference to FIG. 5, cross-over unit 186 applies a cross-over function to the analog audio signal, received from equalizer 184.

In step 300, speaker audio control data is received. The received speaker audio control data includes amplification commands, designated for each of the amplifiers within the digital speaker. It is noted that a single amplification command can be provided to power management unit 198, and be directed to all the amplifiers in a specific digital speaker. With reference to FIG. 5, communication interface 180 receives the speaker audio control data from audio management system 102 of FIG. 1.

This amplification command can be provided once, from power management unit 198 to the power amplifier array 188, for evenly distributing among the amplifiers. A plurality of parameters within the power amplifier array can be controlled. The parameter can be on-off, volume, percentage of maximum gain, and the like.

In step 302, the analog audio signal is amplified for each specific speaker element. With reference to FIG. 5, each of the amplifiers of power amplifier array 188, amplifies a respective analog audio signal, received from cross-over unit 186. The amplified audio signals are provided to each separate speaker, which in turn produces sounds.

In step 304, sounds are detected, thereby producing a plurality of acoustic parameters. Microphone 124 (FIG. 2) detects sounds, either in the vicinity of a selected computerized speaker or in a predetermined location. These detected sounds can be used for the purpose of feedback by audio management system 102 (FIG. 1).

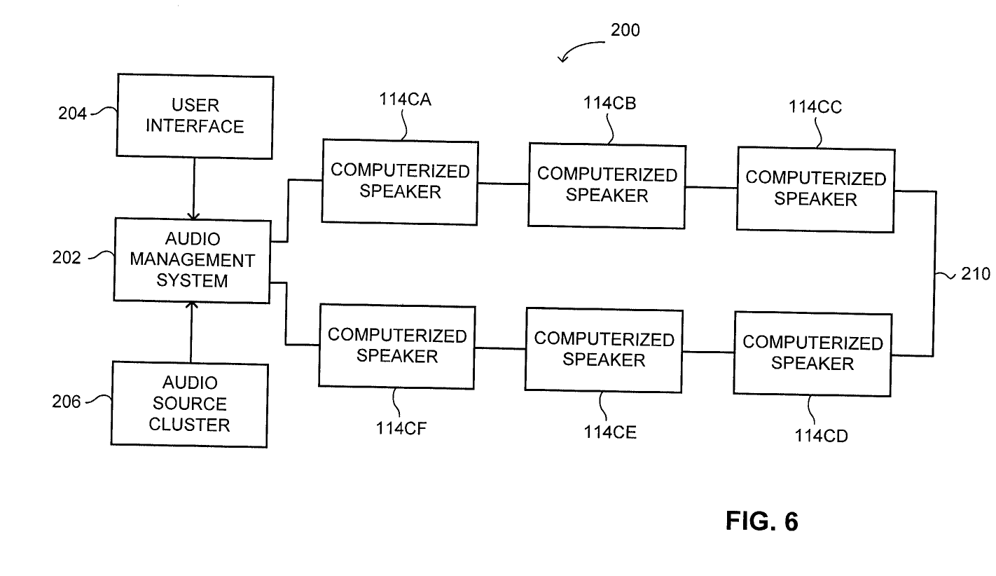

Reference is further made to FIG. 6, which is a schematic illustration of a ring type configured audio system, generally referenced 200, constructed and operative in accordance with a further preferred embodiment of the present invention. Audio system 200 includes an audio management system 202, a user interface 204, an audio source cluster 206, a network 210 and a plurality of computerized speakers 114CA, 114CB, 114CC, 114CD, 114CE and 114CF.

Audio management system 202 is connected to audio source cluster 206, user interface 204 and to network 210. Audio management system 202 is further connected to computerized speakers 114CA, 114CB, 114CC, 114CD, 114CE and 114CF via network 210. Network 210 and computerized speakers 114CA, 114CB, 114CC, 114CD, 114CE and 114CF form a ring networking structure.

Audio management system 202 receives a plurality of digital audio streams from audio source cluster 206. User interface 204 provides user commands to audio management system 202 for processing the received audio streams. Examples regarding user commands are volume, balance, equalization, harmonic envelope, echo, audio effects, and the like. Audio management system 202 processes the digital audio streams according to the user commands and transmits the audio streams and the speaker audio control data to remote computerized speakers via network 210.

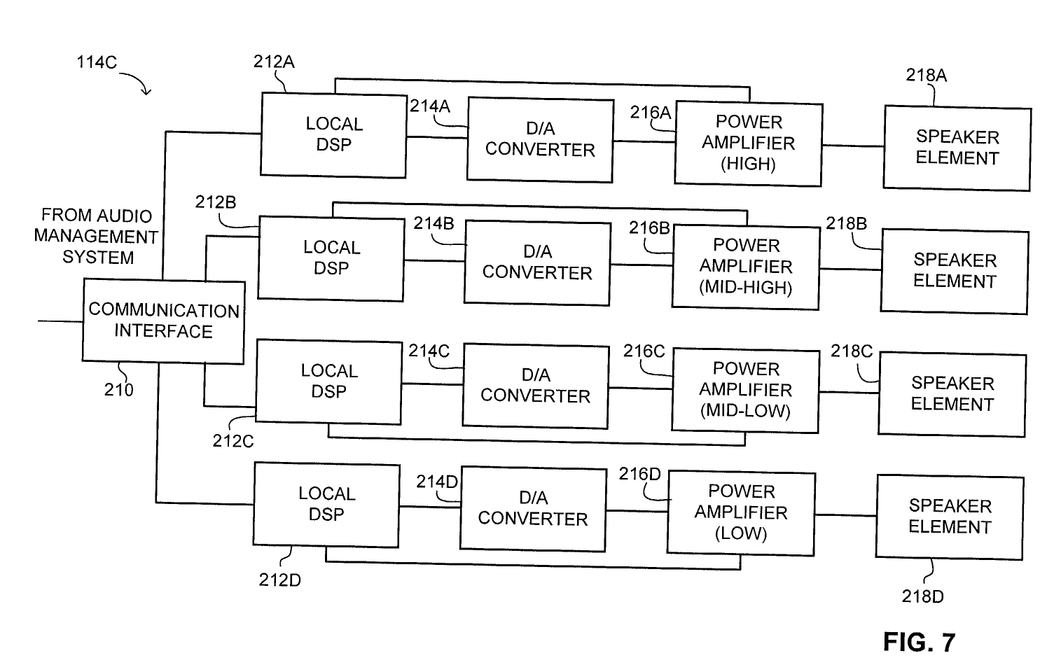

Reference is further made to FIG. 7, which is a another version of schematic illustration of computerized speaker 114C, of FIG. 1, constructed and operative in accordance with another preferred embodiment of the present invention. Computerized speaker 114C includes a communication interface 210, a plurality of local DSPs 212A, 212B, 212C, 212D, a plurality of digital to analog converters (D/A) 214A, 214B, 214C, 214D, a plurality of power amplifiers 216A, 216B, 216C and 216D, and plurality of speaker elements 218A, 218B, 218C and 218D.

Local DSP 212A is connected to communication interface 210 and to D/A converter 214A. Local DSP 212B is connected to communication interface 210 and to D/A converter 214B. Local DSP 212C is connected to communication interface 210 and to D/A converter 214C. Local DSP 212D is connected to communication interface 210 and to D/A converter 214D.

Power amplifier (high) 216A is connected to D/A converter 214A and to speaker element 218A. Power amplifier (mid-high) 216B is connected to D/A converter 214B and to speaker element 218B. Power amplifier (mid-low) 216C is connected to D/A converter 214C and to speaker element 218C. Power amplifier (low) 216D is connected to D/A converter 214D and to speaker element 218D.

Communication interface 210 receives digital audio streams and speaker audio control data, in the form of addressable packets, from audio management system 102 (FIG. 1), and provides each of the packets to at least one of the local DSPs 212A, 212B, 212C and 212C, according to address data embedded in each packet. It is noted that the packet address can include a two stage addressing structure, where the first stage includes the communication interface address and the second stage includes the local DSP address. Alternatively, if each of the local DSP units in the entire set of computerized speakers is unique, then the address can be just of the final destination of the local DSP.

As presented above, a computerized speaker such as computerized speaker 114C includes a plurality (N) of sound processing and production sections, each including a DSP 212N, a D/A converter 214N, a power amplifier 216N and a speaker elements 218N, connected in series. N denotes the index of a reference in a series of similar references. Each of these sections operates in a similar manner. The following description addresses an N section.

Local DSP 212N processes the received packets addressed thereto and extracts the received digital audio stream and the speaker audio control data embedded therein. Local DSP 212N produces a digital audio stream according to the speaker audio control data and provides it to D/A converter 214N. D/A converter 214N converts the digital audio stream to an analog audio signal and provides it to power amplifier 216N. Local DSP 212N provides amplification commands to power amplifier 216N, which in turn amplifies the analog audio signal, received from D/A converter 214N. Power amplifier 216N provides the amplified audio signal to speaker element 218N, which in turn produces sound signals.

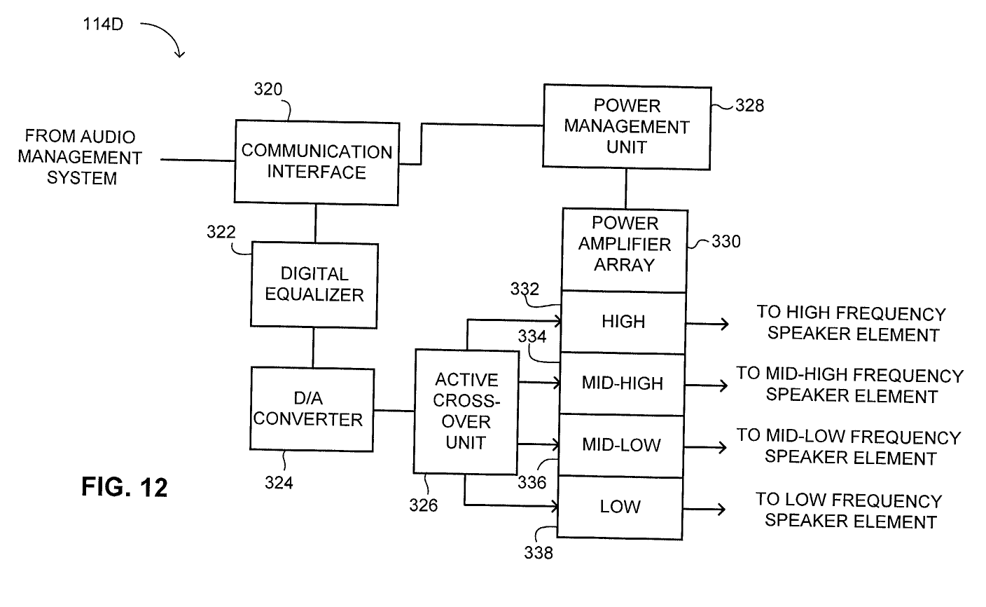

Reference is further made to FIG. 12, which is a schematic illustration in detail of computerized speaker 114D of FIG. 1, constructed and operative in accordance with a further preferred embodiment of the present invention. The number of the computerized speakers, which can be connected to system 100, is virtually unlimited. The system supports a plurality of computerized speaker types and further supports plug and play functionalities, which enable seamless introduction of new types of computerized speakers thereto.

Computerized speaker 114D includes a communication interface 320, a digital equalizer 322, digital to analog converter (D/A) 324, an active cross-over unit 326, a power amplifier array 330, and a power management unit 328. Power amplifier array 330 includes a high frequency bandwidth amplifier 332, a mid-high frequency bandwidth amplifier 334, a mid-low frequency bandwidth amplifier 336 and a low frequency bandwidth amplifier 338.

Communication interface 320 is connected to digital equalizer 322, power management unit 328 and to network 116 (FIG. 1). D/A converter 324 is connected to digital equalizer 322 and to active cross-over unit 326. Power amplifier array 330 is connected to active cross-over unit 326 and to power management unit 328.

Communication interface 320 receives data from audio management system 102 (FIG. 1) via network 116 (FIG. 1). This data includes a digital audio stream, a speaker audio control data and amplification commands. Communication interface 320 provides the received digital audio stream to digital equalizer 322. Communication interface 320 further provides the amplification commands to power management unit 328.

Digital equalizer 322 equalizes the digital audio stream, according to predetermined equalization parameters of the speaker audio control data, and provides the transformed audio stream to D/A converter 324. D/A converter 324 converts the digital audio stream to analog audio signal and further provides it to active cross-over unit 326. Active cross-over unit 326 applies a cross-over function to the analog signal, according to predetermined cross-over parameters respective of the structure of computerized speaker 114D, thereby producing a plurality of analog audio signals. Active cross-over unit 326 provides each of the analog audio signals to the respective amplification unit in power amplifier array 330, which in turn amplifies it according to amplification commands received from communication interface 320 and provides the amplified signal to the respective speaker elements (not shown) connected thereto.

An active cross-over unit, according to the present invention, applies a cross-over function to an audio signal, according to predetermined cross-over parameters determined by real time adaptive analyzer 126 (FIG. 2), in the main program. Thereby, the active cross-over unit produces a plurality of band specific audio signals. The active cross-over unit provides each of the band specific audio signals to a respective audio channel, for further amplification and production as sound. It is noted that the audio channel may further include D/A conversion, when the band specific audio signals are in digital format. The cross-over unit can further dynamically change the band frequency limitation of the specific audio signals.

For example, the mid-high frequency bandwidth amplifier of a specific computerized speaker receives from the active cross-over unit the audio signals of the mid-high and the high frequency bands, and the mid-low frequency bandwidth amplifier receives the audio signals of the mid-low and of the low frequency bands. The high frequency bandwidth amplifier and the low frequency bandwidth amplifier of this computerized speaker receive the audio signals of the high and of the low frequency bands, respectively, without the band frequency limitation changes.

The physical structure of the speaker, the position of the speaker and user predetermined sound parameters determine the band frequency limitation of the produced audio signals. Hence, such an active cross-over unit optimizes sound production, respective of the structure of the computerized speaker and the various speaker elements, which it includes.

Furthermore, the active cross-over unit can perform out-of-phase and in-phase manipulations of the audio source signals, thereby correcting some phase inequalities, which may be exhibited between the different elements of the computerized speaker. By applying dynamic digitized frequency allocation for each of the speaker elements, the active cross-over unit provides a low level form of equalization to the produced analog signal, (e.g., the active cross-over unit can eliminate some inequalities of the speaker passive elements). The active cross-over unit reduces the amount of energy wasted on the element (such as a passive cross speaker element) at all audio power levels.

The technology provided by the present invention, allows to perform automatic testing and calibration of each of the sound producing elements thereof (i.e., computerized speakers and computerized speaker elements). The audio management system can automatically adjust the settings of each of the computerized speakers, as well as manipulate the audio streams provided thereto (i.e., network audio control data and speaker audio control data).

For example, the automatic testing and calibration procedures can set the system for a selected acoustic center. The acoustic center of the audio system is a point with balance of each frequency band sound produced by all computerized speakers. It is noted that the frequency changing and a delay alignment of the produced sound by the computerized speaker can correct the acoustic center.

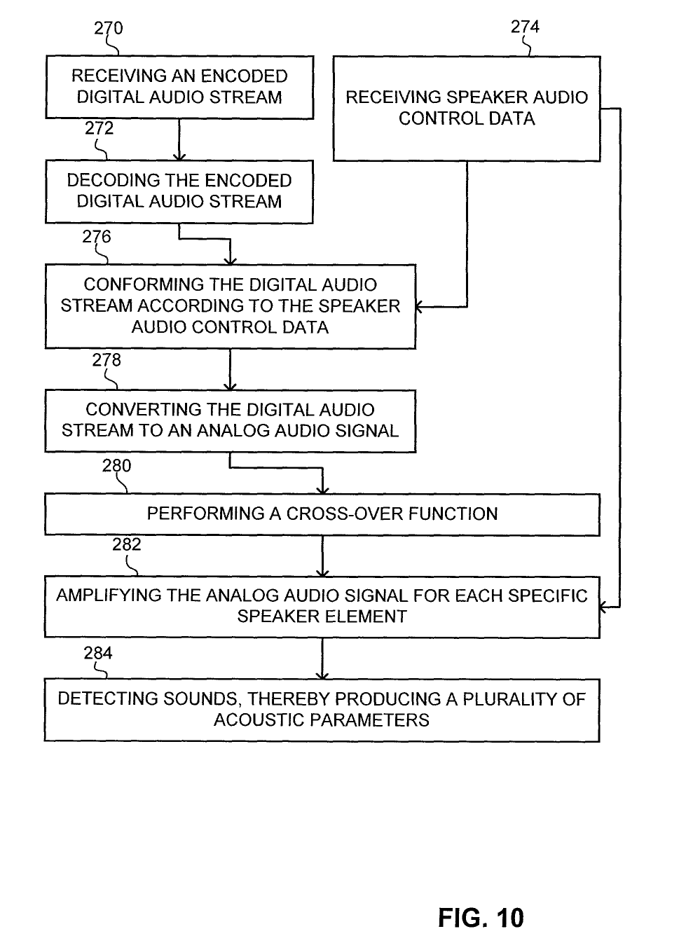

Reference is now made to FIG. 10, which is an illustration of a method for operating computerized speaker 114D of FIG. 12, operative in accordance with another preferred embodiment of the present invention. In step 270, an encoded digital audio stream is received. It is noted that the digital audio stream can be received in an un-encoded format, if transmitted as such. With reference to FIG. 12, communication interface 320 receives encoded digital audio stream, transmitted by audio management system 102 of FIG. 1.

In step 272, the encoded digital audio stream is decoded. It is noted that this step can be eliminated when the digital audio stream is received in an un-encoded format. With reference to FIG. 12, communication interface 320 encodes the digital audio stream received from audio management system 102 of FIG. 1.

In step 274, speaker audio control data is received. The received speaker audio control data includes predetermined equalization parameters and amplification commands. With reference to FIG. 12, communication interface 320 receives the speaker audio control data from audio management system 102 of FIG. 1.

In step 276 the digital audio streams are conformed according to equalization parameters. It is noted that the equalization parameters can be predetermined or dynamically updated via the network. With reference to FIG. 12, digital equalizer 322 equalizes the digital audio stream received from communication interface 320. Digital equalizer 322 can be pre-programmed or dynamically programmed by means of speaker audio control data, received by communication interface 320.

In step 278, the digital audio stream is converted to an analog audio signal. With reference to FIG. 12, D/A converter 324 converts the digital audio stream, received from digital equalizer 322 to analog audio signal.

In step 280, a cross-over function is applied on the analog audio signal. The cross-over function is pre-set according to the acoustic and electronic characteristics of the elements comprising the computerized speaker. With reference to FIG. 12, active cross-over unit 326 applies active cross-over function to the analog audio signal received from D/A converter 324.

In step 282, the analog audio signal is amplified for each specific speaker element. With reference to FIG. 12, power amplifier array 330 amplifies the analog audio signal, received from active cross-over unit 326. It is noted that communication interface 320 produces amplification commands designated for each of the amplifiers of power amplifier array 330, according to the received speaker audio control data. The amplified audio signals are provided to each separate speaker element, which in turn produces sound.

In step 284, sounds are detected, thereby producing a plurality of acoustic parameters. Microphone 124 (FIG. 2) detects sounds, either in the vicinity of a selected computerized speaker or in a predetermined location. These detected sounds can be used for the purpose of feedback by audio management system 102 (FIG. 1).

It will be appreciated by persons skilled in the art that the present invention is not limited to what has been particularly shown and described here in above. Rather the scope of the present invention is defined only by the claims, which follow.

1. Audio system for operating a plurality of speakers, the audio system comprising:
an audio management system connected to said speakers via a network;
a user interface connected to said audio management system; and
an audio source cluster connected to said audio management system,
wherein said audio management system operates said speakers by transmitting audio streams and speaker audio control data to said network, and
wherein said audio management system determines said speaker audio control data, according to a plurality of parameters.

2. The audio system according to claim 1, wherein a selected ones of said speakers are connected to said network via a plurality of routers.

3. The audio system according to claim 1, wherein a selected ones of said speakers are connected to said network via a plurality of wireless transceivers.

4. The audio system according to claim 1, wherein the type of said network is selected from the list consisting of:
ring;
star; and
combination of ring and star.

5. The audio system according to claim 1, wherein said audio management system transmits said audio streams and said speaker audio control data to each of said speakers, according to an address of a respective one of said speakers.

6. The audio system according to claim 1, wherein the type of said parameters is selected from the list consisting of:
automatic;
user defined; and
automatic and user defined.

7. The audio system according to claim 1, wherein said audio management system operates according to a digital isochronous protocol selected from the list consisting of:
Universal Serial Bus;
high speed IEEE 1394; and
Short Distance Wireless Blue-tooth format.

8. The audio system according to claim 1, wherein said network operates according to a network protocol selected from the list consisting of:
Ethernet; and
ATM.

9. The audio system according to claim 1, wherein a user transmits user defined parameters to said audio management system, via said user interface.

10. The audio system according to claim 1, wherein said speaker audio control data include at least one audio parameter, selected from the list consisting of:
volume;
balance;
equalization;
harmonic envelop;
echo effects;
audio effects;
phase; and
time-delay.

11. The audio system according to claim 1, wherein said audio management system further comprises a digital signal processor, and a central processing unit, said central processing unit connected to said user interface.

12. The audio system according to claim 11, wherein said digital signal processor further comprises a real time adaptive analyzer connected to said audio source cluster and to a microphone, and a master band equalizer connected to said real time adaptive analyzer, said central processing unit and to said network via a communication interface, wherein said microphone listens to said speakers, and said real time adaptive analyzer comprises a user defined sound parameter.

13. The audio system according to claim 11, wherein said digital signal processor further comprises a real time adaptive analyzer connected to said audio source cluster and to a microphone, a master band equalizer connected to said real time adaptive analyzer, and to said central processing unit, and an audio encoder connected to said network via a communication interface, said audio encoder further connected to said master band equalizer and to said central processing unit, wherein said microphone listens to said speakers, and said audio encoder transmits an encoded speaker element control parameter to said communication interface.

14. The audio system according to claim 13, wherein said digital signal processor further comprises an audio decoder connected to said audio source cluster and to said real time adaptive analyzer.

15. The audio system according to claim 14, wherein the type of operation of said audio decoder is selected from the list consisting of:
de-multiplexing;
separating said audio streams;
converting said audio streams from a first digital format to a second digital format; and
decompressing said audio streams.

16. The audio system according to claim 1, wherein the type of said audio streams is selected from a list consisting of:
Dolby Logic;
Dolby Pro-Logic;
Dolby Digital 5.1 channels;
Digital Theatrical Sound; and
UCPASS multi-channel encoded audio source.

17. The audio system according to claim 12, wherein said real time adaptive analyzer transmits parameter sets to said master band equalizer.

18. The audio system according to claim 17, wherein the type of said parameter sets is selected from the list consisting of:
quality sharpness of a band-pass filter; and
gain of a filter.

19. The audio system according to claim 12, wherein said master band equalizer operates in a mode selected from the list consisting of:
automatic; and
manual.

20. The audio system according to claim 1, wherein said user interface comprises a master bass control means and a master treble control means.

21. The audio system according to claim 1, wherein a user transmits said parameters to said user interface via an input output device selected from the list consisting of:
video;
audio; and
tactile.

22. The audio system according to claim 13 wherein said encoded speaker element control parameter is selected from the list consisting of:
delay;
volume;
equalization; and
cross.

23. The audio system according to claim 12, wherein said real time adaptive analyzer maintains a status of last operation.

24. The audio system according to claim 12, wherein said user defined sound parameter is selected from the list consisting of:
Concert;
Classical-Hall;
Jazz;
Stadium;
Pop; and
Rock.

25. The audio system according to claim 1, wherein said audio source cluster further comprises a plurality of analog audio sources, a plurality of digital audio sources, an analog to digital converter, a sampling rate converter, and a multiplexor,
wherein said analog to digital converter is connected to said analog audio sources and to said multiplexor, said sampling rate converter is connected to said digital audio sources and to said multiplexor, and said multiplexor is connected to said audio management system.

26. The audio system according to claim 1, wherein each of said speakers further comprises a communication interface, a local digital signal processor, a first digital to analog converter, a second digital to analog converter, a power management unit, a power amplifier array, a high frequency speaker element, a mid-high frequency speaker element, a mid-low frequency speaker element, and a low frequency speaker element.

27. The audio system according to claim 26, wherein said power amplifier array further comprises a high frequency bandwidth amplifier, a mid-high frequency bandwidth amplifier, a mid-low frequency bandwidth amplifier, and a low frequency bandwidth amplifier.

28. The audio system according to claim 27, wherein said communication interface is connected to said network and to said local digital signal processor, said local digital signal processor is connected to said first digital to analog converter, said second digital to analog converter and to said power management unit, said power management unit is connected to said power amplifier array, said high frequency bandwidth amplifier is connected to said first digital to analog converter and to said high frequency speaker element, said mid-high frequency bandwidth amplifier is connected to said first digital to analog converter and to said mid-high frequency speaker element, said mid-low frequency bandwidth amplifier is connected to said second digital to analog converter and to said mid-low frequency speaker element, and said low frequency bandwidth amplifier is connected to said second digital to analog converter and to said low frequency speaker element.

29. The audio system according to claim 26, wherein said local digital signal processor transmits amplification commands to said first digital to analog converter and to said second digital to analog converter.

30. The audio system according to claim 26, wherein said local digital signal processor transmits a characteristic of a respective one of said speakers to said audio management system, via said network.

31. The audio system according to claim 30, wherein said characteristic is selected from the list consisting of:
physical structure;
frequency response;
amplification ability;
harmonic distortion values;
protocol support;
programmable aspects; and
cross over configuration.

32. The audio system according to claim 1, wherein each of said speakers further comprises a communication interface, a digital to analog converter, an equalizer, a cross-over unit, a power management unit, a power amplifier array, a high frequency speaker element, a mid-high frequency speaker element, a mid-low frequency speaker element, and a low frequency speaker element.

33. The audio system according to claim 32, wherein said power amplifier array further comprises a high frequency bandwidth amplifier, a mid-high frequency bandwidth amplifier, a mid-low frequency bandwidth amplifier, and a low frequency bandwidth amplifier.

34. The audio system according to claim 33, wherein said communication interface is connected to said network, said digital to analog converter and to said power management unit, said equalizer is connected to said digital to analog converter and to said cross-over unit, said power management unit is connected to said power amplifier array, said high frequency bandwidth amplifier is connected to said cross-over unit and to said high frequency speaker element, said mid-high frequency bandwidth amplifier is connected to said cross-over unit and to said mid-high frequency speaker element, said mid-low frequency bandwidth amplifier is connected to said cross-over unit and to said mid-low frequency speaker element, and said low frequency bandwidth amplifier is connected to said cross-over unit and to said low frequency speaker element.

35. The audio system according to claim 32, wherein said audio management system transmits amplification commands to said communication interface via said network.

36. The audio system according to claim 35, wherein the type of said amplification commands can be selected from the list consisting of:
on-off;
volume control; and
percentage of maximum gain of said power amplifier array during operation.

37. The audio system according to claim 1, wherein each of said speakers further comprises a communication interface, a digital equalizer, a digital to analog converter, an active cross-over unit, a power management unit, a power amplifier array, a high frequency speaker element, a mid-high frequency speaker element, a mid-low frequency speaker element, and a low frequency speaker element.

38. The audio system according to claim 37, wherein said power amplifier array further comprises a high frequency bandwidth amplifier, a mid-high frequency bandwidth amplifier, a mid-low frequency bandwidth amplifier, and a low frequency bandwidth amplifier.

39. The audio system according to claim 38, wherein said communication interface is connected to said network, said digital equalizer and to said power management unit, said digital to analog converter is connected to said digital equalizer and to said active cross-over unit, said power management unit is connected to said power amplifier array, said high frequency bandwidth amplifier is connected to said active cross-over unit and to said high frequency speaker element, said mid-high frequency bandwidth amplifier is connected to said active cross-over unit and to said mid-high frequency speaker element, said mid-low frequency bandwidth amplifier is connected to said active cross-over unit and to said mid-low frequency speaker element, and said low frequency bandwidth amplifier is connected to said active cross-over unit and to said low frequency speaker element.

40. The audio system according to claim 38, wherein said active cross-over unit changes a band frequency limitation of a frequency band of said audio streams according to predetermined cross-over parameters.

41. The audio system according to claim 40, wherein type of said band frequency limitation is selected from the list consisting of:
physical structure of a respective one of said speakers;
position of a respective one of said speakers; and
user predetermined sound parameters.

42. The audio system according to claim 38, wherein said active cross-over unit performs an out-of-phase manipulation and an in-phase manipulation on said audio streams.

43. Method for operating an audio system, the audio system including an audio management system, a user interface, an audio source cluster and a plurality of speakers, wherein the speakers are connected to the audio management system via a network, and the audio management system is connected to the user interface and to the audio source cluster, the method comprising the steps of:
determining network audio control data according to automatic predetermined parameters and user defined parameters;
conforming audio streams according to said network audio control parameters;
encoding said conformed audio streams; and
determining speaker audio control data according to said automatic predetermined parameters and said user defined parameters.

44. The method according to claim 43, further comprising a preliminary step of decoding a multiplexed form of digital audio streams.

45. The method according to claim 44, further comprising a preliminary step of multiplexing said digital audio streams.

46. The method according to claim 45, further comprising a preliminary step of converting said digital audio streams to digital audio streams with a predetermined sampling rate, when said digital audio streams are received from a digital audio source.

47. The method according to claim 45, further comprising a preliminary step of converting an analog audio signal to said digital audio streams, when said analog signal is received from an analog audio source.

48. The method according to claim 43, comprising a further step of transmitting said encoded audio streams and said speaker audio control data to a selected one of said speakers.

49. Method for operating an audio system, the audio system including an audio management system, a user interface, an audio source cluster and a plurality of speakers, each of the speakers including a speaker element, wherein the speakers are connected to the audio management system via a network, and the audio management system is connected to the user interface and to the audio source cluster, the method comprising the steps of:
amplifying an analog audio signal;
providing said amplified analog audio signal to each of said speaker elements;
detecting sounds from each of said speaker elements; and
producing an acoustic parameter respective of said sounds.

50. The method according to claim 49, further comprising a preliminary step of converting a digital audio signal to said analog audio signal.

51. The method according to claim 50, further comprising a preliminary step of conforming said digital audio signal according to speaker audio control data.

52. The method according to claim 51, further comprising a preliminary step of receiving said speaker audio control data.

53. The method according to claim 51, further comprising a preliminary step of decoding an encoded digital audio signal.

54. The method according to claim 53, further comprising a preliminary step of receiving said encoded digital audio signal.

55. The method according to claim 49, further comprising a step of transmitting said acoustic parameters to a control unit.

56. Method for operating an audio system, the audio system including an audio management system, a user interface, an audio source cluster and a plurality of speakers, each of the speakers including a speaker element, wherein the speakers are connected to the audio management system via a network, and the audio management system is connected to the user interface and to the audio source cluster, the method comprising the steps of:
performing a cross-over function on an analog audio signal;
amplifying said analog audio signal for each of said speaker elements;
detecting sounds from each of said speaker elements; and
producing an acoustic parameter respective of said sounds.

57. The method according to claim 56, further comprising a preliminary step of converting a digital audio signal to said analog audio signal.

58. The method according to claim 57, further comprising a preliminary step of conforming said digital audio signal according to speaker audio control data.

59. The method according to claim 58, further comprising a preliminary step of receiving said speaker audio control data.

60. The method according to claim 58, further comprising a preliminary step of decoding an encoded digital audio signal.

61. The method according to claim 60, further comprising a preliminary step of receiving said encoded digital audio signal.

62. Method for operating an audio system, the audio system including an audio management system, a user interface, an audio source cluster and a plurality of speakers, each of the speakers including a speaker element, wherein the speakers are connected to the audio management system via a network, and the audio management system is connected to the user interface and to the audio source cluster, the method comprising the steps of:
performing a cross-over function on an equalized analog audio signal;
amplifying said equalized analog audio signal for each of said speaker elements;
detecting sounds from each of said speaker elements; and
producing an acoustic parameter respective of said sounds.

63. The method according to claim 62, further comprising a preliminary step of receiving speaker audio control data.

64. The method according to claim 62, further comprising a preliminary step of equalizing an analog audio signal.

65. The method according to claim 64, further comprising a preliminary step of converting a digital audio signal to said analog audio signal.

66. The method according to claim 65, further comprising a preliminary step of decoding an encoded digital audio signal.

67. The method according to claim 66, further comprising a preliminary step of receiving said encoded digital audio signal.
